(19) United States
(12) Patent Application Publication
(10) Pub. No.: US 2021/0234624 A1
(43) Pub. Date: Jul. 29, 2021

(54) Method for Displaying Audio Content Currently Available From Other Sources on a Receiving Device

(71) Applicant: Michael Conley, Auburn, CA (US)

(72) Inventor: Michael Conley, Auburn, CA (US)

(21) Appl. No.: 16/775,074

(22) Filed: Jan. 28, 2020

(51) Int. Cl. H04H 60/72; H04H 20/47; H04H 20/51; H04H 60/37; H04H 60/58; H04H 60/73

(52) U.S. Cl. CPC H04H 60/72; H04H 20/47; H04H 60/73; H04H 60/372; H04H 60/58; H04H 20/51

(57) ABSTRACT

A method for providing information to the user of receiving device of audio content to determine what other content besides that which is currently being listened to is available through the receiving device without changing what is being listened to. This will take information being provided by the sender of the audio content or others and make it available to the user of the receiving device in such a way that they can know in real time, or near real time, what audio content is available through other means on the device. This will allow users to make more informed decisions about changes to the audio content they are listening to, thus preventing or minimizing changes that prove to be misguided due to the content of the channel the user switches to being something they don't want to hear. This will also enable the user to make changes when they become aware, via the information provided about the content of other sources, that there is something they would prefer to hear as compared to that which they are currently listening to as well as compared to the other available options. Essentially, this invention will provide users with information about the audio content choices of a receiving device without the need for the user to sample each source that may or may not have something that the user wishes to listen to.

### BACKGROUND—PRIOR ART

The following is a tabulation of some prior art that presently appears relevant:

Patent Number Issue Date Patentee

None Found

### BACKGROUND OF THE INVENTION

The capability to display information about music, talk shows, sportscasts, and other audio content has existed for some time. This is often transmitted in real time or near real time with the audio content, allowing receiving devices of that audio content that are capable of gathering and displaying that information to present the transmitted information on the device receiving the audio content, and/or providing that information to the listener or listeners of that audio content. Whether displaying the name of the artist singing the audio content along with other song information, conveying the details of a talk show, showing which sports teams are playing during a particular sportscast, or many other types of audio transmissions that are sent by a variety of methods such as traditional radio, satellite radio, over internet connection, over cell phone connection, or sent in any other manner, the ability to get details about the current content is already available. What is lacking is a means to see what is currently available and being transmitted from other sources that are available to the receiving device receiving the audio content, without the need for the user of the device to change what content they are hearing. Recipients of audio content would benefit from being able to see what is available from one or more other sources of audio content without the need to change which audio source they are listening to and/or displaying. This invention seeks to take the information already being transmitted with the audio content, and broaden what is made available to the device, and therefore to the listener or listeners of the receiving device.

By knowing what is available on one or more other sources of audio content prior to changing the audio source being listened to by the user or users of the receiving device, these users will be able to make a more informed choice when changing from one source of audio content to another.

The value of this functionality would be significant. This would be applicable and useful when making decisions about what audio source to select, without the need to jump from one source to another, wondering if the desired content will be currently available or the switch from one audio source to another will prove unfortunate as the content currently playing on a particular source is not what the listener was looking for.

### SUMMARY OF THE INVENTION

This invention seeks to use information about the audio content already available to a receiving device capable of receiving audio content, such as music, talk shows, sportscasts, instruction, and many other forms of audio content, to provide additional information to the user or users of the device about other content available on the device. This can be done by displaying a description of the available content from select sources (presets) or by displaying a list of some or all available sources along with a description of the content from each source, without the need for the user of the device to actually change the source to which they are listening. They will know what is available from the other sources of audio content by taking in the sensory information available to them to describe the content from the various available sources of audio content.

In short, this invention will allow the receiving device capable of receiving audio content from more than source to display a description of the audio content available from other sources, enabling the listener of that device to know what content is currently available on other sources through the device prior to changing the active source. This will enable the listener to make a more informed decision when considering a change from the currently selected audio content on the receiving device.

### DRAWING—FIGURES

FIG. 1 shows how this might look displayed on a screen where the current content of pre-selected presets from terrestrial (such as FM and AM) radio is shown, displaying what content is currently available on these other sources without actually needing to switch to any of these sources.

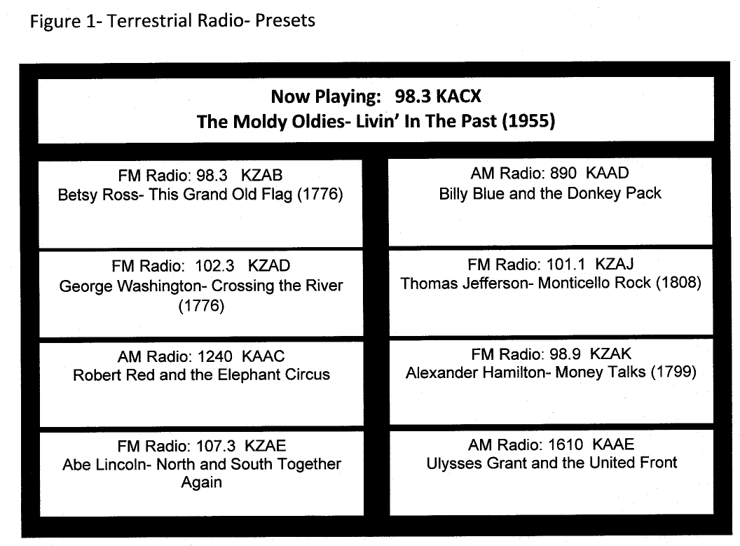

FIG. 2 shows how this might look displayed on a screen where the current content of a list of some or all of the available sources from terrestrial (such as FM and AM) radio is shown, displaying what content is currently available on these other sources without actually needing to switch to any of these sources.

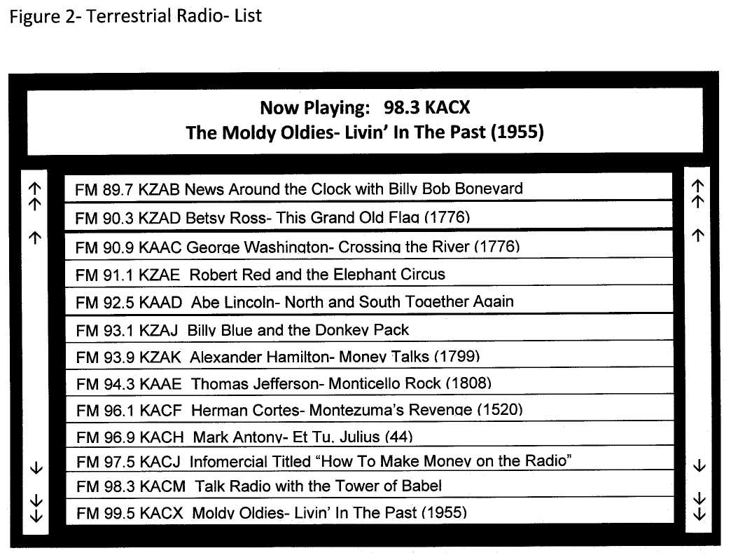

FIG. 3 shows how this might look displayed on a screen where the current content of pre-selected presets from satellite radio is shown, displaying what content is currently available on these other sources without actually needing to switch to any of these sources.

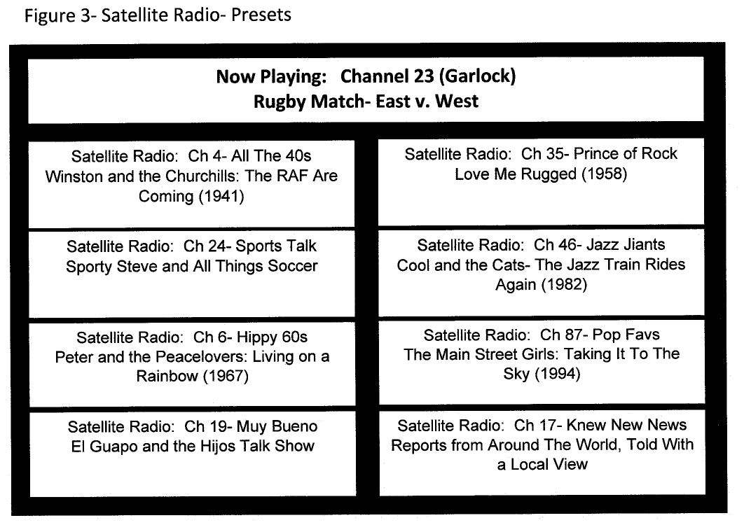

FIG. 4 shows how this might look displayed on a screen where the current content of a list of some or all of the available sources from satellite radio is shown, displaying what content is currently available on these other sources without actually needing to switch to any of these sources.

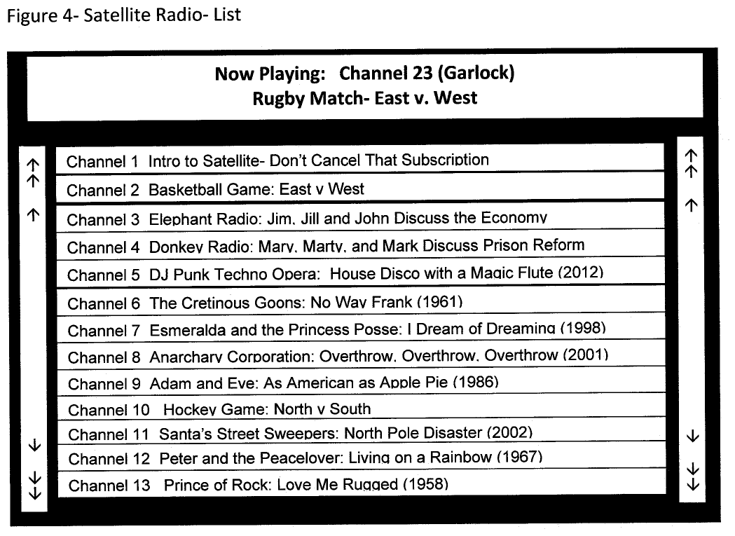

FIG. 5 shows how this might look displayed on a screen where the current content of pre-selected presets from streaming audio sources is shown, displaying what content is currently available on these other sources without actually needing to switch to any of these sources.

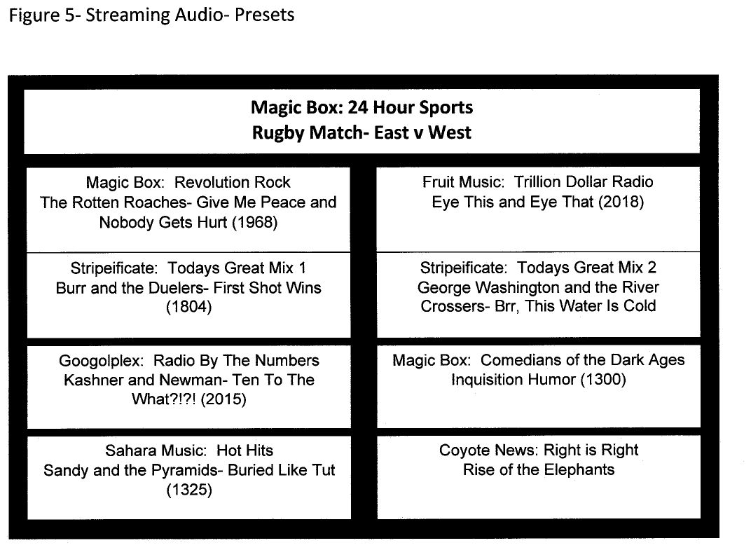

FIG. 6 shows how this might look displayed on a screen where the current content of a list of some or all of the available sources from streaming audio sources is shown, displaying what content is currently available on these other sources without actually needing to switch to any of these sources.

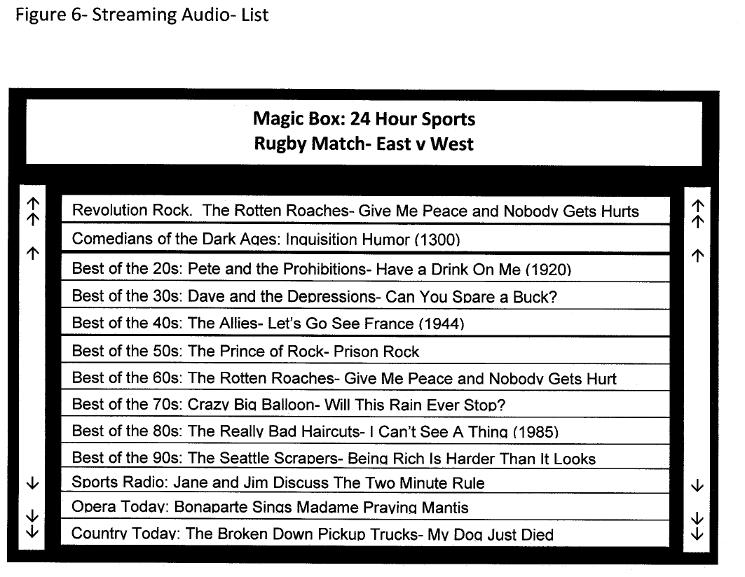

FIG. 7 shows how this might look displayed on a screen where the current content of pre-selected presets from some combination of terrestrial (such as FM and AM), satellite, and/or streaming audio sources is shown, displaying what content is currently available on these other sources without actually needing to switch to any of these sources.

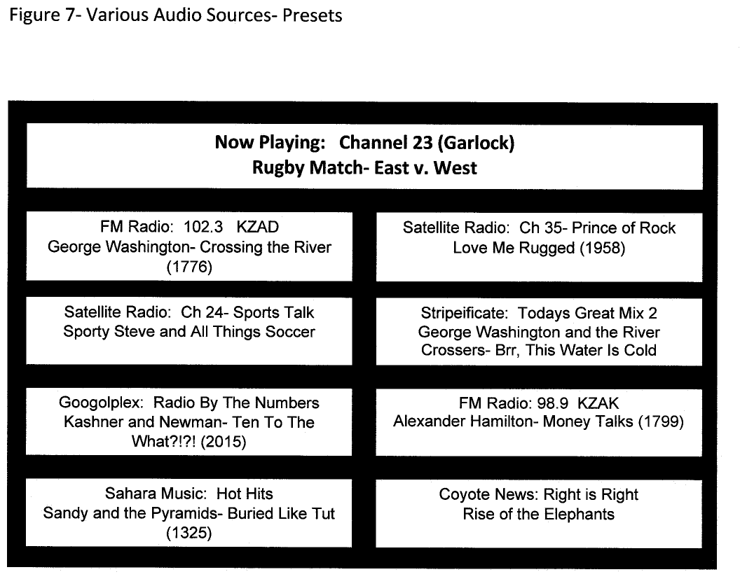

FIG. 8 shows how this might look displayed on a screen where the current content of a list of some or all of the available sources from some combination of terrestrial (such as FM and AM), satellite, and/or streaming audio sources is shown, displaying what content is currently available on these other sources without actually needing to switch to any of these sources.

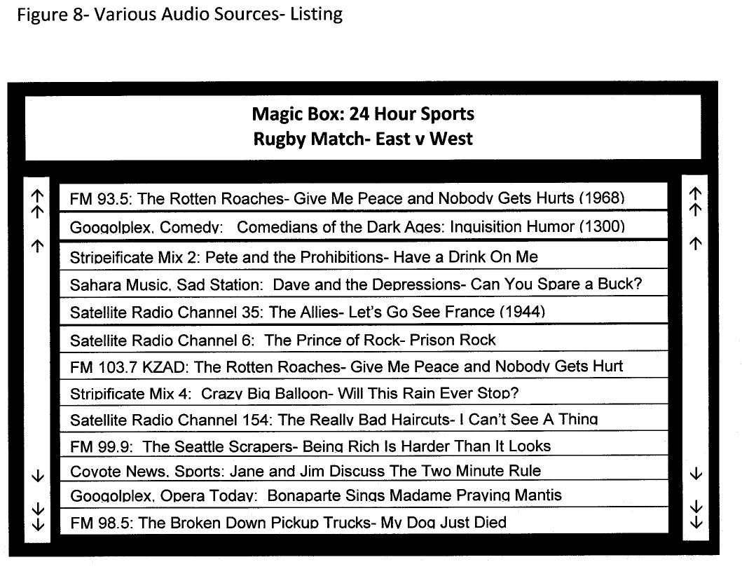

### DETAILED DESCRIPTION

While listening to particular audio content, or no audio content at all, the user of a receiving device of audio content, such as a car stereo, a computer, a tablet, or many other devices capable of receiving audio content, can see a description as provided by the transmitter or other provider of the audio content of other audio content available on the device. This information about the audio content is often already provided, and this invention does not seek to develop or otherwise determine how that descriptive information about audio content is provided. This invention seeks to take information about audio content already being transmitted to the receiving device of audio content and make it more useful to the user or users of the device by allowing those users to see in real time, or near real time, a description of the audio content elsewhere available on the device. The ability to see information about what is currently active on a device capable of receiving audio content has long been available, but there is not a way to see what is available on other channels, through other services, or through other capabilities of a device capable of receiving audio content.

By way of example, the audio/entertainment system on many modern vehicles includes a screen to display various information, including entertainment system information. If the user selects a particular FM radio station, or a particular satellite radio station, information about the current audio on that station will be displayed, showing perhaps the artist who sings the song playing, the title of the song, the year the song was released, and various other information. For a talk show, it may show the host of the show and various other information. For educational content, it may display both the person or people providing the content, a description of the topic, and other information that may be of interest to the listener. However, while the listener in such a vehicle can get information about the content to which they are currently tuned, they are unable to see what is playing on other FM radio stations, on other satellite radio stations, or audio content otherwise available to the receiving device such as internet content or via other methods available to the device. They can see a listing of other options available, such as other radio stations, a listing of satellite radio stations, and other content, but they are unable to see in real time, or near real-time, what content is currently available on those sources.

This invention seeks to gather information already being sent to the receiving device of audio content and make it available more broadly and in a more useful manner than is currently available. This information will be gathered and processed so as to be made available to the user of the receiving device, allowing the user to see with greater specificity what content is currently available through other means on the device without the need for the user to actually change what content they are currently listening to. This will be accomplished by gathering the information included to the receiving device about the content and displaying it or otherwise making it available to the user of the receiving device. The designer and/or manufacturer of the device will determine how the information is made available and the options available for the presentation of such information, but this may be from a combination of displaying information about the contents of other sources that have been pre-defined by the user (presets) or by displaying information about the contents of all or some of the other sources in a list format. Given space limitations on the sensory unit of the receiving device, the content may be truncated, may be scrolled, or otherwise have a way to handle when the content is not of the correct format or size to be provided to the user.

As shown in the drawings, this information can be displayed in a variety of ways, with many other methods and formats available besides those specifically shown herein. But this invention seeks to make information that is already being provided to the receiving device of audio content more fully available to the user of the device, giving that user the ability to know what other content is available through the device prior to or contemporaneous with the user changing which audio content they choose on the device. This will simultaneously help prevent changes to content that the user does not want to hear while also enabling changes to content to something that the user does want to hear as they can quickly and easily know what is on other sources without changing what they are currently listening to.

### CONCLUSION

The ability to see the already provided description of audio content available on a device capable of receiving such audio content without the need to change which content is being listened to will provide a significant improvement of the user experience related to audio content. This will assist with preventing a user from changing a station or otherwise altering the content being listened to, only to discover they have switched to something they don't want to hear. This will also assist the user in more easily identifying a change they may wish to make when they can know what audio content is available on other sources available on the device capable of receiving audio content. This invention relies on the providers of audio content or some other source to provide the information about the audio content. How that information is transmitted, the standards for that transmission, and the like are outside the realm of this invention. This invention seeks to better utilize that information, presenting it to the user in such a way that it becomes more useful and more actionable. By providing information about available audio content on a receiving device without the need for the user to change what they are currently listening to, the user is afforded greater information to make better informed decisions about whether to change what they are listening to and to choose which other option for audio content they wish to choose.

Although the description above contains many specificities, these should not be construed to limit the scope of the utility of this capability but as merely providing illustrations of some of several uses.

1. A method for providing a user of a receiving device used to listen to audio content with information about other audio content available on the receiving device
while the receiving device is playing any audio content or no audio content, source; and
given that this information is already provided by many providers of audio content or other sources of information about audio content, but currently the information is only displayed regarding the audio content from the currently-selected audio source.

2. A method for a receiving device of audio content to capture, assemble, and provide information about other audio content available to the receiving device:
making this information available to a user of the receiving device in such a way that the user can quickly decide based on the content of other sources whether the user would like to change the source to which the user is listening or not; and
while the receiving device is playing any audio content or no audio content.

3. A method by which a receiving device will present information about other content available to the device while the receiving device is playing any audio content or no audio content,
whether by:
presenting the content of a pre-defined set of sources (presets); or
a list of some/all available audio content; or
a combination;
which will simultaneously assist a user in finding desirable audio content as well as avoiding undesirable content.
